(19) United States
(12) Patent Application Publication
(10) Pub. No.: US 2026/0155723 A1
(43) Pub. Date: Jun. 4, 2026

(54) ACTUATOR

(71) Applicant: NIDEC INSTRUMENTS CORPORATION, Nagano (JP)

(72) Inventor: Shinji HATANO, Nagano (JP)

(21) Appl. No.: 19/403,601

(22) Filed: Nov. 28, 2025

(30) Foreign Application Priority Data
Nov. 29, 2024 (JP) 2024-207894

(51) Int. Cl. H02K 33/18

(52) U.S. Cl. CPC H02K 33/18

(57) ABSTRACT

The yoke of the actuator includes a first connecting plate portion extending in the Z direction in the first through portion of the coil holder, and a second connecting plate portion extending in the Z direction in the second through portion. The power supply substrate is disposed at an end portion of the coil holder on the Y1 side. The lead-out wires led out from the coils extend to the side of the power supply substrate and are soldered to the power supply substrate. The distance in the Y1 direction between the inner surface of the first through portion located on the Y1 side and the first connecting plate portion is larger than the distance in the direction between the inner surface of the second through portion located on the Y2 side and the second connecting plate portion.

### CROSS REFERENCE TO RELATED APPLICATION

The present invention claims priority under 35 U.S.C. § 119 to Japanese Application No. 2024-207894 filed Nov. 29, 2024, the entire content of which is incorporated herein by reference.

### BACKGROUND

### Field of the Invention

At least an embodiment of the present invention relates to an actuator.

### Description of the Related Documents

Japanese Unexamined Patent Application Publication No. 2020-102902 and Japanese Unexamined Patent Application Publication No. 2022-158373 disclose an actuator in which a movable body including a magnet and a support body including a coil are connected to each other via a connection body composed of an elastic body or a viscoelastic body, and the movable body is vibrated with respect to the support body when a drive current is applied to the coil. The support body of Japanese Unexamined Patent Application Publication No. 2020-102902 and Japanese Unexamined Patent Application Publication No. 2022-158373 includes a coil holder provided with a coil arrangement hole. A lead-out wire of a coil wire led out from the coil arranged in the coil arrangement hole is accommodated in a groove formed on a surface of the coil holder, led out to an end surface in a longitudinal direction of the coil holder, and connected to a power supply substrate fixed to the end surface in the longitudinal direction of the coil holder.

When an impact is applied to the actuator due to a drop or the like, a large tension may be applied to the lead-out wire that connects the coil and the power supply substrate, and thereby, the lead-out wire may be disconnected. Therefore, in Japanese Unexamined Patent Application Publication No. 2020-102902, a slack is provided in a portion of the lead-out wire routed from an outlet of the groove in the coil holder in which the lead-out wire is disposed to the surface of the power supply substrate. Similarly, in Japanese Unexamined Patent Application Publication No. 2022-158373, a concave portion is provided on the bottom surface of the groove in which the lead-out wire is disposed, and a slack is provided in a portion of the lead-out wire in the groove. When the lead-out wire is provided with a slack, it is possible to prevent a large tension from being applied to the lead-out wire. Therefore, the possibility of disconnection can be reduced.

In the related art, as in Japanese Unexamined Patent Application Publication No. 2020-102902 and Japanese Unexamined Patent Application Publication No. 2022-158373, a configuration in which disconnection is avoided by providing a slack in a lead-out wire between a coil and a power supply substrate is adopted. However, there may be a case where the slack cannot be provided due to a method of assembling an actuator.

An object of at least an embodiment of the present invention is to propose an actuator capable of reducing the possibility of disconnection even when a slack cannot be formed in a lead-out wire.

### SUMMARY

According to an aspect of the present invention, there is provided an actuator comprising: a support body and a movable body; a connection body that has at least one of elastic property and viscoelastic property, is disposed at a position where the movable body and the support body face each other, and connects the movable body and the support body to each other; and a magnetic drive circuit that comprises a coil disposed in a coil holder provided on the support body and a magnet fixed to a yoke provided on the movable body and facing the coil in a first direction, and vibrates the movable body with respect to the support body in a second direction intersecting the first direction, wherein a power supply substrate is fixed to an end portion of the coil holder on one side in the second direction, a lead-out wire led out from the coil extends toward a side of the power supply substrate and is soldered to the power supply substrate, the coil holder is provided with a coil arrangement hole in which the coil is arranged, a first through portion located on a side of the power supply substrate with respect to the coil arrangement hole, and a second through portion located on a side opposite to the power supply substrate with respect to the coil arrangement hole, and the yoke comprises a first plate portion facing the coil from one side in the first direction, a second plate portion facing the coil from an other side in the first direction, a first connecting plate portion extending in the first through portion in the first direction and connecting the first plate portion and the second plate portion, and a second connecting plate portion extending in the second through portion in the first direction and connecting the first plate portion and the second plate portion, and when it is assumed that a distance in the second direction between a first facing portion of an inner surface of the first through portion that faces the first connecting plate portion from a side of the power supply substrate and the first connecting plate portion is defined as a first distance, a distance in the second direction between a second facing portion of an inner surface of the first through portion that faces the first connecting plate portion from a side opposite to the power supply substrate and the first connecting plate portion is defined as a second distance, a distance in the second direction between a third facing portion of an inner surface of the second through portion that faces the second connecting plate portion from a side of the power supply substrate and the second connecting plate portion is defined as a third distance, and a distance in the second direction between a fourth facing portion of an inner surface of the second through portion that faces the second connecting plate portion from a side opposite to the power supply substrate and the second connecting plate portion is defined as a fourth distance, the first distance is larger than the third distance.

According to an aspect of the present invention, there is provided an actuator comprising: a support body and a movable body; a connection body that has at least one of elastic property and viscoelastic property, is disposed at a position where the movable body and the support body face each other, and connects the movable body and the support body to each other; and a magnetic drive circuit that comprises a coil disposed in a coil holder provided on the support body and a magnet fixed to a yoke provided on the movable body and facing the coil in a first direction, and vibrates the movable body with respect to the support body in a second direction intersecting the first direction, wherein a power supply substrate is fixed to an end portion of the coil holder on one side in the second direction, a lead-out wire led out from the coil extends toward a side of the power supply substrate and is soldered to the power supply substrate, the coil holder is provided with a coil arrangement hole in which the coil is arranged, a first through portion located on a side of the power supply substrate with respect to the coil arrangement hole, and a second through portion located on a side opposite to the power supply substrate with respect to the coil arrangement hole, and the yoke comprises a first plate portion facing the coil from one side in the first direction, a second plate portion facing the coil from an other side in the first direction, a first connecting plate portion extending in the first through portion in the first direction and connecting the first plate portion and the second plate portion, and a second connecting plate portion extending in the second through portion in the first direction and connecting the first plate portion and the second plate portion, and when it is assumed that a distance in the second direction between a first facing portion of an inner surface of the first through portion that faces the first connecting plate portion from a side of the power supply substrate and the first connecting plate portion is defined as a first distance, a distance in the second direction between a second facing portion of an inner surface of the first through portion that faces the first connecting plate portion from a side opposite to the power supply substrate and the first connecting plate portion is defined as a second distance, a distance in the second direction between a third facing portion of an inner surface of the second through portion that faces the second connecting plate portion from a side of the power supply substrate and the second connecting plate portion is defined as a third distance, and a distance in the second direction between a fourth facing portion of an inner surface of the second through portion that faces the second connecting plate portion from a side opposite to the power supply substrate and the second connecting plate portion is defined as a fourth distance, the second distance is larger than the fourth distance.

### BRIEF DESCRIPTION OF THE DRAWINGS

Embodiments will now be described, by way of example only, with reference to the accompanying drawings which are meant to be exemplary, not limiting, and wherein like elements are numbered alike in several figures, in which:

FIG. 1 is an external perspective view of an actuator;

FIG. 2 is an exploded perspective view of the actuator;

FIG. 3 is a cross-sectional view of the actuator taken along a YZ plane;

FIG. 4 is a cross-sectional view of the actuator taken along an XZ plane;

FIG. 5 is an exploded perspective view of a coil holder, a plate, a coil, and a power supply substrate as viewed from a Z2 direction;

FIG. 6 is an exploded perspective view of the coil holder, the plate, the coil, and the power supply substrate as viewed from a Z1 direction;

FIG. 7 is a partial plan view of the coil holder;

FIG. 8 is a partial perspective view of the coil holder;

FIG. 9 is a front view of the coil holder and the power supply substrate;

FIG. 10 is a cross-sectional view of a guide groove and a lead-out wire; and

FIG. 11 is a cross-sectional view of the actuator taken along an XY plane.

### DETAILED DESCRIPTION

An embodiment of an actuator will now be described with reference to the drawings. In the present specification, three directions including a Z direction, a Y direction, and an X direction are directions orthogonal to each other. The Z direction is a first direction. The Y direction is a second direction. The X direction is a third direction. One side in the Z direction is a Z1 direction and the other side in the Z direction is a Z2 direction. One side in the Y direction is a Y1 direction and the other side in the Y direction is a Y2 direction. One side in the X direction is an X1 direction and the other side in the X direction is an X2 direction.

### Overall Configuration

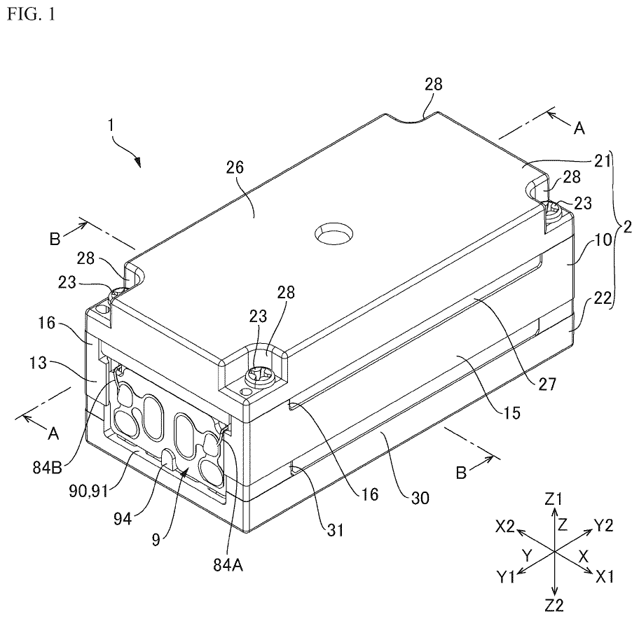

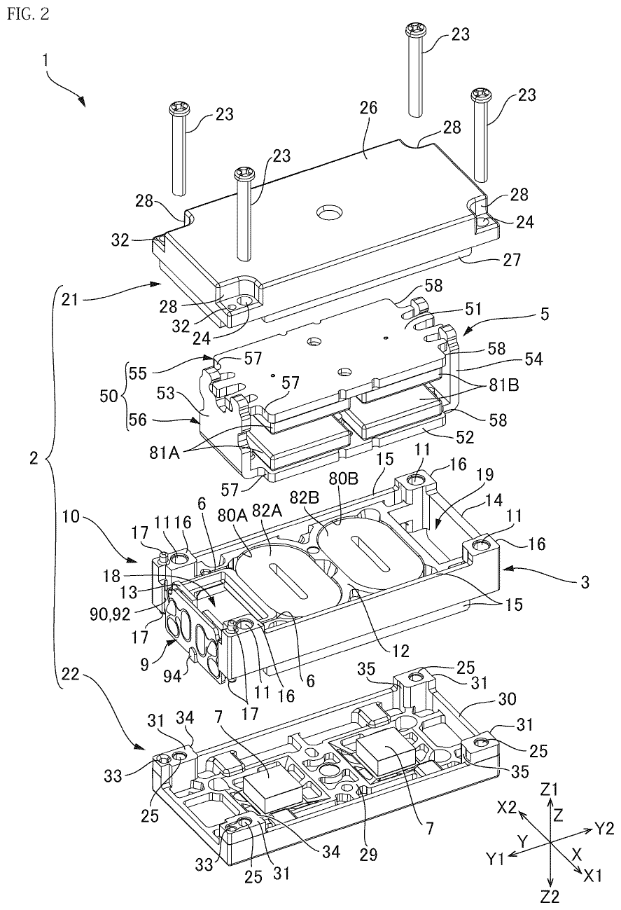

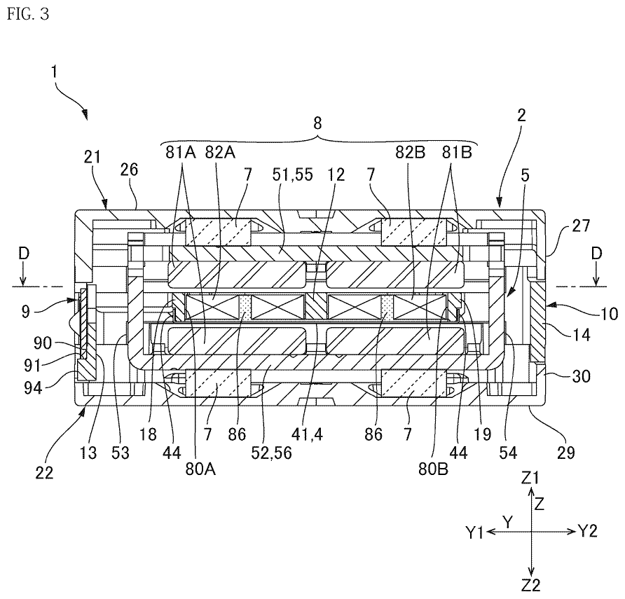

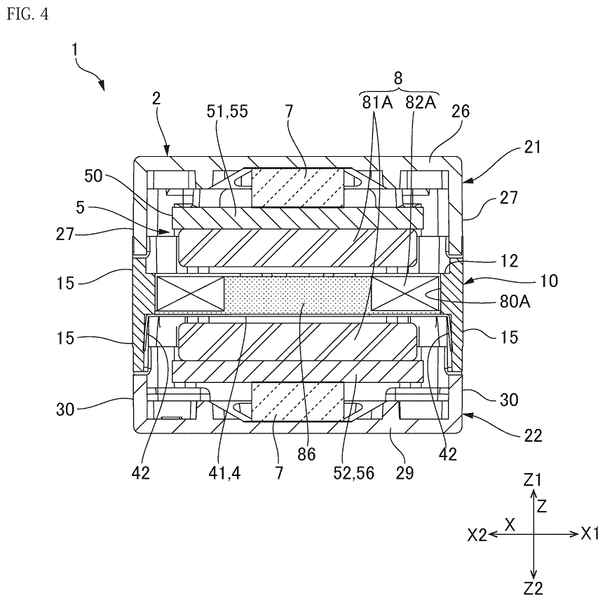

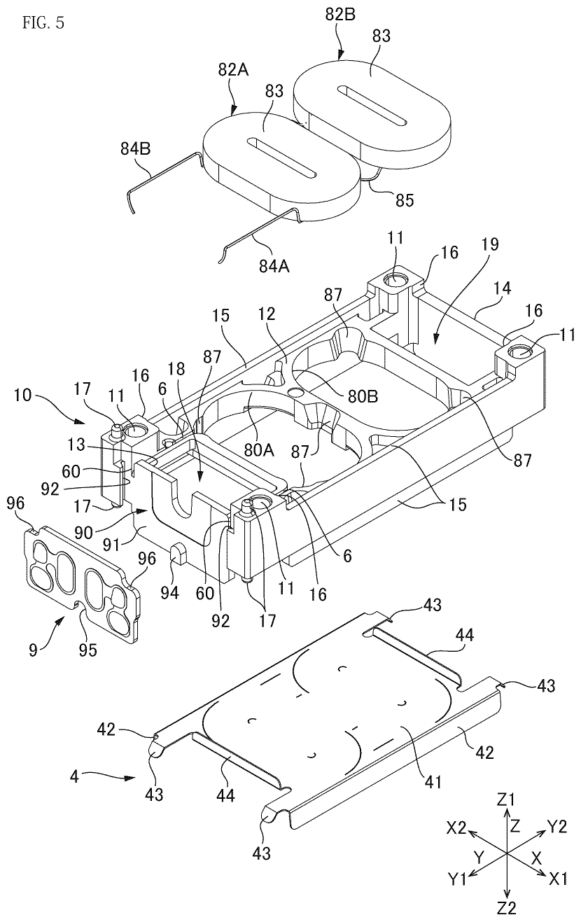

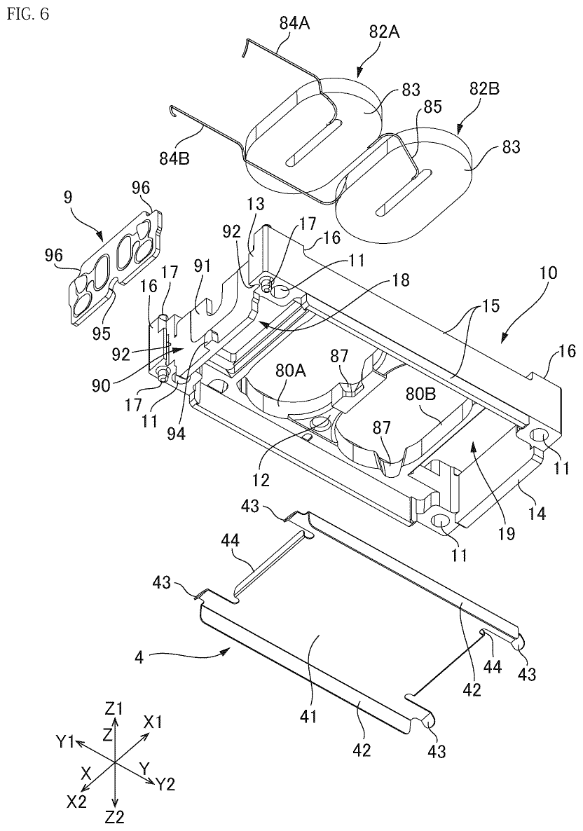

FIG. 1 is an external perspective view of an actuator 1. FIG. 2 is an exploded perspective view of the actuator 1. FIG. 3 is a cross-sectional view of the actuator 1 taken along a YZ plane, that is, a cross-sectional view of the actuator 1 taken along an A-A position in FIG. 1. FIG. 4 is a cross-sectional view of the actuator 1 taken along an XZ plane, that is, a cross-sectional view of the actuator 1 taken along a B-B position in FIG. 1. FIG. 5 is an exploded perspective view of a coil holder 10, a plate 4, coils 82A and 82B, and a power supply substrate 9 as viewed from the Z2 direction. FIG. 6 is an exploded perspective view of the coil holder 10, the plate 4, the coils 82A and 82B, and the power supply substrate 9 as viewed from the Z1 direction.

The actuator 1 is used as a tactile device that transmits information by vibrations. As shown in FIG. 1, the actuator 1 has a rectangular parallelepiped shape whose longitudinal direction is the Y direction. The Z direction is a thickness direction of the actuator 1. As illustrated in FIGS. 3 and 4, the actuator 1 includes a support body 2 and a movable body 5 that is accommodated inside the support body 2. Furthermore, the actuator 1 includes a connection body 7 that connects the support body 2 and the movable body 5 to each other, and a magnetic drive circuit 8 that moves the movable body 5 relative to the support body 2 in the Y direction. The connection body 7 is disposed at a position where the movable body 5 and the support body 2 face each other in the Z direction. The connection body 7 has at least one of elastic property and viscoelastic property.

The magnetic drive circuit 8 includes magnets 81A and 81B disposed on the movable body 5, and coils 82A and 82B disposed on the support body 2. The support body 2 includes a power supply substrate 9 for supplying power to the coils 82A and 82B. The magnets 81A and 81B are arranged in the Y direction. The coils 82A and 82B are arranged in the Y direction. As shown in FIG. 3, the magnets 81A and the coil 82A face each other in the Z direction, and the magnets 81B and the coil 82B face each other in the Z direction. The coil 82A located on the Y1 side is a first coil. The coil 82B located on the Y2 side is a second coil. As shown in FIG. 2, the coils 82A and 82B are elliptic air-core coils elongated in the X direction. Each of the coils 82A and 82B includes two effective sides extending in the X direction. Therefore, the magnetic drive circuit 8 generates a magnetic driving force for vibrating the movable body 5 with respect to the support body 2 in the Y direction.

### Support Body

As shown in FIGS. 1 and 2, the support body 2 includes a coil holder 10, a first case 21 that overlaps the coil holder 10 from the Z1 direction, and a second case 22 that overlaps the coil holder 10 from the Z2 direction. The first case 21, the coil holder 10, and the second case 22 are made of resin. The first case 21, the coil holder 10, and the second case 22 are joined together by four screws 23. The screws 23 penetrate through fixing holes 24 passing through the four corners of the first case 21 in the Z direction and fixing holes 11 passing through the four corners of the coil holder 10 in the Z direction, and are screwed into fixing holes 25 provided at the four corners of the second case 22.

The first case 21 includes a first end plate portion 26 having a rectangular shape when viewed in the Z direction, and an edge portion 27 protruding to the Z2 direction from both ends of the first end plate portion 26 in the Y direction and both ends of the first end plate portion 26 in the X direction. Concave portions 28 recessed to the Z1 direction are provided at the four corners of the first end plate portion 26. A boss portion (not shown) having a shape surrounding the concave portion 28 is provided inside the first case 21, and four corners of the edge portion 27 of the first case 21 where the boss portion is provided are cut out. As shown in FIG. 1, a boss portion 16 of the coil holder 10, which will be described later, is fitted into the cutout portion of the edge portion 27. The fixing holes 24 pass through the first case 21 at the four corners where the concave portions 28 are provided.

The second case 22 includes a second end plate portion 29 having a rectangular shape when viewed in the Z direction, an edge portion 30 that protrudes to the Z1 direction from both ends of the second end plate portion 29 in the X direction and an end portion of the second end plate portion 29 on the Y2 direction, and boss portions 31 that protrude to the Z2 direction from four corners of the second end plate portion 29. The fixing hole 25 is opened on the tip end surface of the boss portion 31.

The coil holder 10 includes a plate portion 12 provided with two coil arrangement holes 80A and 80B, a first end plate portion 13 provided at an end portion of the plate portion 12 on the Y1 direction, a second end plate portion 14 provided at an end portion of the plate portion 12 on the Y2 direction, and edge portions 15 provided at both ends of the plate portion 12 in the X direction. The first end plate portion 13, the second end plate portion 14, and the edge portions 15 protrude to both sides of the plate portion 12 in the Z direction. Both ends of the first end plate portion 13 in the X direction and both ends of the second end plate portion 14 in the third direction are respectively provided with boss portions 16 that protrude from the plate portion 12 to both sides in the Z direction. The fixing hole 11 passes through each of the four boss portions 16.

Positioning pins 17 respectively protrude to the Z1 direction and the Z2 direction from each of two boss portions 16 provided at an end portion on the Y1 direction among the four boss portions 16. The positioning pins 17 protruding to the Z1 direction are fitted into positioning holes 32 opened in the concave portions 28 of the first case 21. The positioning pins 17 protruding to the Z2 direction are fitted into positioning holes 33 provided in the boss portions 31 of the second case 22.

The coil arrangement holes 80A and 80B pass through the plate portion 12 in the Z direction. The coil arrangement hole 80A located on the Y1 side is a first coil arrangement hole. The coil arrangement hole 80B located on the Y2 side is a second coil arrangement hole. The coil holder 10 includes a first through portion 18 provided between the coil arrangement hole 80A and the first end plate portion 13, and a second through portion 19 provided between the coil arrangement hole 80B and the second end plate portion 14. The first through portion 18 and the second through portion 19 have a rectangular shape when viewed in the Z direction and pass through the plate portion 12 in the Z direction.

### Substrate Holding Portion

As shown in FIGS. 1 and 2, the power supply substrate 9 is held at an end portion of the coil holder 10 on the Y1 direction. The first end plate portion 13 includes a substrate holding portion 90 that holds the power supply substrate 9. The substrate holding portion 90 includes a substrate accommodating concave portion 91 recessed to the Y2 direction, a pair of slits 92 provided at both ends of the substrate accommodating concave portion 91 in the X direction, and a substrate receiving portion 94 protruding to the Y1 direction from the center of the end portion of the substrate accommodating concave portion 91 on the Z1 direction. The slits 92 extend in the Z direction and face each other in the X direction. The power supply substrate 9 is provided so that the both ends of the power supply substrate 9 in the X direction are inserted into the slits 92 and the power supply substrate 9 abuts on the substrate receiving portion 94 from the Z2 direction. The substrate receiving portion 94 is fitted into a cutout portion 95 (see FIG. 5) provided at the center of the edge portion of the power supply substrate 9 on the Z1 direction.

### Plate

As shown in FIGS. 3 and 4, the support body 2 includes a plate 4 attached to the coil holder 10 from the Z2 direction. The plate 4 is made of nonmagnetic metal. As shown in FIGS. 5 and 6, the plate 4 includes a planar portion 41 that overlaps the plate portion 12 from the Z2 direction, two claw portions 42 that are provided at both ends of the planar portion 41 in the X direction, and four claw portions 43 that are provided at both ends in the X direction on both ends of the planar portion 41 in the Y direction. Two claw portions 42 protrude obliquely to the Z2 direction toward the outside in the X direction from both ends of the planar portion 41 in the X direction. Four claw portions 43 protrude obliquely to the Z1 direction toward the outside in the Y direction from both ends of the planar portion 41 in the Y direction.

As shown in FIG. 4, when the plate 4 is assembled to the coil holder 10, the two claw portions 42 elastically contact the edge portions 15 of the coil holder 10 from the inner side. Similarly, when the plate 4 is assembled to the coil holder 10, the four claw portions 43 elastically contact the boss portions 16 of the coil holder 10 from the inner side.

Further, in the plate 4, a cutout portion is provided at a central portion in the X direction on both ends of the planar portion 41 in the Y direction, and a bent portion 44 protruding to the Z1 direction is provided at an edge of the cutout portion. As shown in FIG. 3, the two bent portions 44 are fitted to stepped portions provided on the inner surface of the first through portion 18 on the Y2 direction and the inner surface of the second through portion 19 on the Y1 direction.

### Coil

As shown in FIGS. 5 and 6, each of the coils 82A and 82B includes a winding portion 83 formed by winding a coil wire to form an elliptic shape. As shown in FIG. 5, two lead-out wires 84A and 84B are led out from the Z1 side of the winding portion 83 of the coil 82A on the Y1 side. As shown in FIG. 6, the lead-out wire 84A on the X1 side is led out from the center of the winding portion 83 of the coil 82A on the Y1 side. The lead-out wire 84B on the X2 side is led out from the outer peripheral edge of the winding portion 83 of the coil 82B on the Y2 side. A connecting wire 85 connecting the coils 82A and 82B is led out from the center of the winding portion 83 of the coil 82B on the Y2 side, and is connected to the outer peripheral edge of the winding portion 83 of the coil 82A on the Y1 side.

As shown in FIGS. 2 and 5, a guide groove 6 extending in the Y direction is provided on both sides of the first through portion 18 in the X direction on the surface of the plate portion 12 of the coil holder 10 on the Z1 side. The lead-out wires 84A and 84B extending to the Y1 direction from the coils 82A and 82B are accommodated in the guide grooves 6, routed to the substrate holding portion 90 provided on a surface of the first end plate portion 13 on the Y1 side, and then soldered to the lands provided on a surface of the power supply substrate 9 on the Y1 side.

When assembling the actuators 1, the coils 82A and 82B, the plate 4, and the power supply substrate 9 are assembled to the coil holder 10. At this time, an adhesive 86 is put around the winding portion 83 and in the central hole of the winding portion 83, and the coils 82A and 82B are fixed by the adhesive 86. Thus, a coil set 3 shown in FIG. 2 is formed. As shown in FIG. 5, the inner peripheral surfaces of the coil arrangement hole 80A and the coil arrangement hole 80B are provided with an adhesive reservoir 87 recessed toward the outer peripheral side. The adhesive 86 supplied from the adhesive reservoir 87 spreads in a gap between the winding portion 83 and the inner peripheral surface of the coil arrangement hole 80A, a gap between the winding portion 83 and the inner peripheral surface of the coil arrangement hole 80B, and gaps between the plate 4 and the winding portions 83.

As shown in FIG. 6, the two lead-out wires 84A and 84B and the connecting wire 85 are all routed on the Z2 side of the winding portion 83. When the coil set 3 is assembled, the coil 82A is arranged in the coil arrangement hole 80A, and the coil 82B is arranged in the coil arrangement hole 80B. At this time, the connecting wire 85 is passed through the Z2 side of the plate portion 12. When the plate 4 is assembled to the plate portion 12, the connecting wire 85 is accommodated in a gap between the plate portion 12 and the planar portion 41 of the plate 4. The lead-out wires 84A and 84B are accommodated in a gap between the winding portion 83 and the planar portion 41 of the plate 4, bent to the Z1 direction at the edge of the winding portion 83 on the Y1 side, and then accommodated in the guide grooves 6.

### Movable Body

The movable body 5 includes magnets 81A and 81B and a yoke 50. The magnet 81A is disposed at two positions on the Z1 direction and the Z2 direction of the coil 82A. The magnet 81B is disposed at two positions on the Z1 direction and the Z2 direction of the coil 82B.

The yoke 50 is made of a magnetic material. As shown in FIGS. 2, 3, and 4, the yoke 50 includes a first plate portion 51 facing the coils 82A and 82B from the Z1 direction, a second plate portion 52 facing the coils 82A and 82B from the Z2 direction, a first connecting plate portion 53 connecting the end portion of the first plate portion 51 on the Y1 direction and the end portion of the second plate portion 52 on the Y1 direction, and a second connecting plate portion 54 connecting the end portion of the first plate portion 51 on the Y2 direction and the end portion of the second plate portion 52 on the Y2 direction.

The yoke 50 is configured by assembling two components, i.e., a first yoke 55 composed of the first plate portion 51 and a second yoke 56 including the second plate portion 52, the first connecting plate portion 53, and the second connecting plate portion 54. Tip ends of the first connecting plate portion 53 and the second connecting plate portion 54 bent from both ends of the second plate portion 52 in the Y direction toward the Z2 direction are joined to both ends of the first plate portion 51 in the Y direction by welding or the like.

The magnet 81A facing the coil 82A from the Z1 direction and the magnet 81B facing the coil 82B from the Z1 direction are fixed to the first plate portion 51 of the yoke 50. The magnet 81A facing the coil 82A from the Z2 direction and the magnet 81B facing the coil 82B from the Z2 direction are fixed to the second plate portion 52 of the yoke 50. As shown in FIG. 3, the first connecting plate portion 53 of the yoke 50 extends in the Z direction through the first through portion 18 of the coil holder 10. The second connecting plate portion 54 extends in the Z direction through the second through portion 19 of the coil holder 10. The opening widths of the first through portion 18 and the second through portion 19 in the Y direction are set to such a dimension that, when the movable body 5 vibrates at a predetermined stroke in the Y direction, the first connecting plate portion 53 and the second connecting plate portion 54 do not collide with the inner surfaces of the first through portion 18 and the second through portion 19.

### Connection Body

As shown in FIGS. 3 and 4, the connection body 7 is disposed between the yoke 50 and the first case 21 and between the yoke 50 and the second case 22. The connection body 7 is compressed in the Z direction between the yoke 50 and the first case 21 and between the yoke 50 and the second case 22. More specifically, two connection bodies 7 arranged in the Y direction are disposed between the first plate portion 51 and the first end plate portion 26. Similarly, two connection bodies 7 arranged in the Y direction are disposed between the second plate portion 52 and the second end plate portion 29. As shown in FIG. 2, the connection body 7 has a rectangular parallelepiped shape, and the four connection bodies 7 have the same shape.

The connection body 7 has at least one of an elastic body and a viscoelastic body. In this embodiment, the connection body 7 is a gel-like member made of silicone gel. Silicone gel is a viscoelastic body whose spring constant when deformation occurs in an expansion/contraction direction is approximately three times greater than the spring constant when deformation occurs in a shear direction. When a viscoelastic body is deformed in a direction (shear direction) that intersects a thickness direction, the viscoelastic body has deformation characteristics in which the linear component is larger than the nonlinear component since the deformation in the shear direction is a deformation in a direction in which the viscoelastic body is pulled and stretched. Furthermore, when a viscoelastic body is subjected to compression deformation by being pressed in the thickness direction, the viscoelastic body has expansion/contraction characteristics in which the nonlinear component is larger than the linear component. On the other hand, when the viscoelastic body is pulled and stretched in the thickness direction, the viscoelastic body has expansion/contraction characteristics in which the linear component is larger than the nonlinear component.

Alternatively, the connection body 7 may be formed using various rubber materials such as natural rubber, diene rubber (such as styrene-butadiene rubber, isoprene rubber, butadiene rubber, chloroprene rubber, and acrylonitrile-butadiene rubber), non-diene rubber (such as butyl rubber, ethylene-propylene rubber, ethylene-propylene-diene rubber, urethane rubber, silicone rubber, and fluoro-rubber), thermoplastic elastomers, and modified materials of these rubber materials.

### Operation of Actuator

When a current in a predetermined direction is supplied to the coils 82A and 82B via the power supply substrate 9, the movable body 5 supported by the support body 2 moves relative to the support body 2 to the Y1 direction or the Y2 direction by a driving force of the magnetic drive circuit 8. When the direction of the current supplied to the coils 82A and 82B is repeatedly reversed, the movable body 5 vibrates in the Y direction at a predetermined stroke with respect to the support body 2. When the movable body 5 vibrates in the Y direction, the connection body 7 is shear-deformed. When the supply of the current to the coils 82A and 82B is stopped, the movable body 5 is returned to the origin position by the elastic returning force of the connection bodies 7 at the four positions, and is held at the origin position.

### Guide Groove

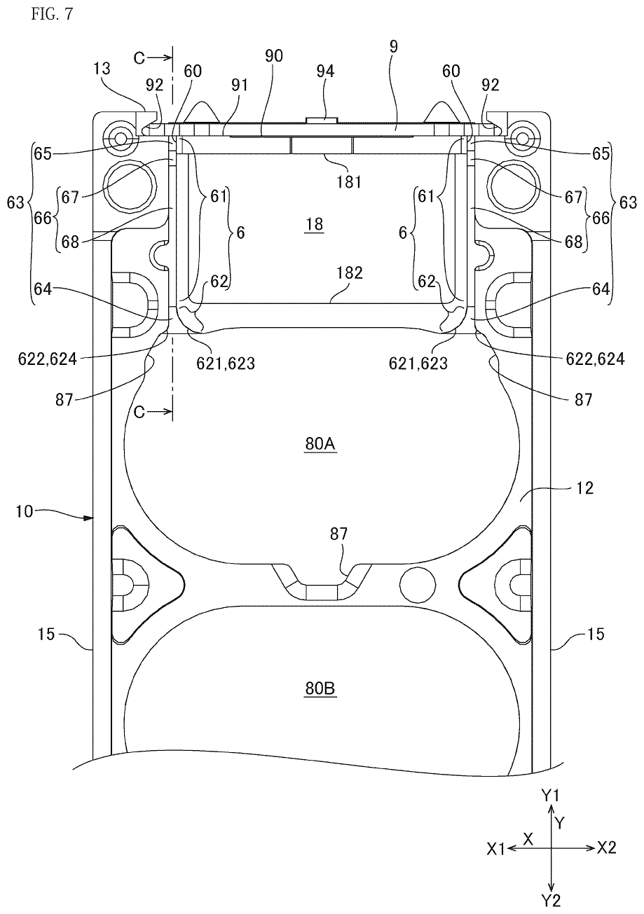

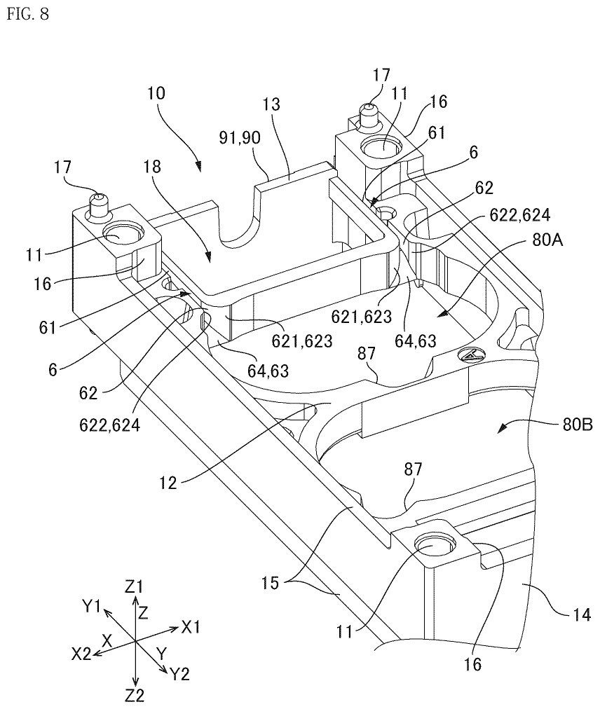

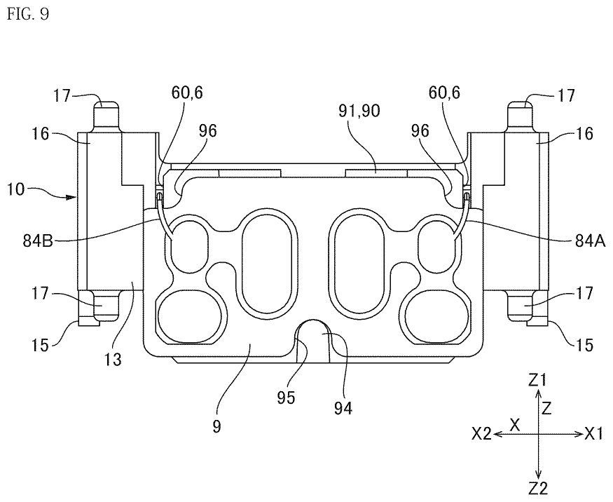

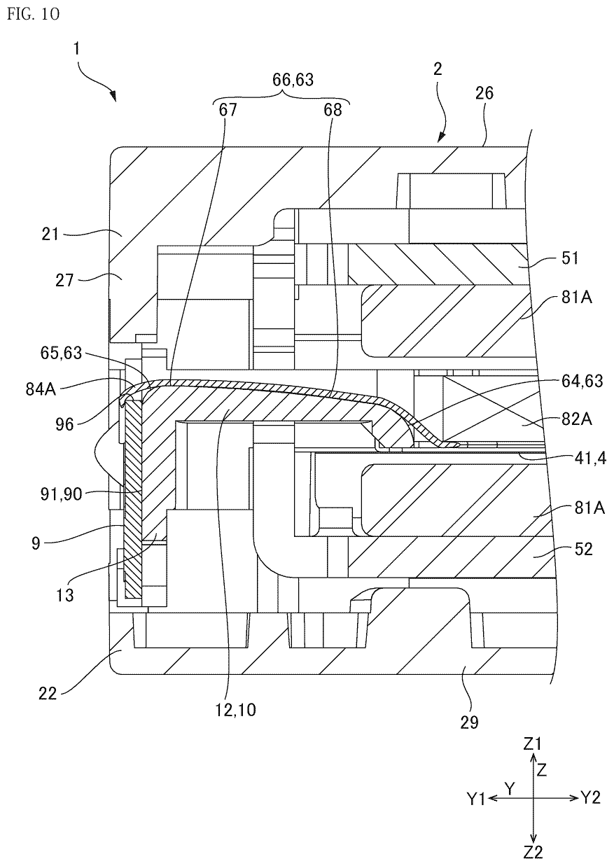

FIG. 7 is a partial plan view of the coil holder 10. FIG. 8 is a partial perspective view of the coil holder 10. FIG. 9 is a front view of the coil holder 10 and the power supply substrate 9. FIG. 10 is a cross-sectional view of the guide groove 6 and the lead-out wire 84A, and is a cross-sectional view of the actuator 1 taken along position C-C in FIG. 7. As shown in FIGS. 7 and 8, the guide groove 6 extends on a surface of the plate portion 12 of the coil holder 10 on the Z1 direction from the coil arrangement hole 80A to the substrate holding portion 90.

As shown in FIGS. 7 and 9, the end portion of the guide groove 6 on the Y1 side passes through the first end plate portion 13 of the coil holder 10 and is connected to the opening portion 60 that opens on a surface of the substrate holding portion 90. A cutout portion 96 cut out to the Z2 direction is formed at both ends in the X direction on the end portion of the power supply substrate 9 on the Z1 direction. When the power supply substrate 9 is attached to the substrate holding portion 90, the opening portions 60 of the guide grooves 6 are positioned at the cutout portions 96 of the power supply substrate 9 as shown in FIG. 9. Therefore, the lead-out wires 84A and 84B are led out from the opening portions 60 to the cutout portions 96 of the power supply substrate 9, are bent to the Z2 direction, extend to the Z2 direction via the end portion of the power supply substrate 9 on the Z1 direction, and are routed to the lands provided on the surface of the power supply substrate 9.

As shown in FIG. 7, the guide groove 6 includes a linear portion 61 linearly extending from the opening portion 60 toward the side of the coil arrangement hole 80A, and a groove end portion 62 connecting the linear portion 61 and the coil arrangement hole 80A. As shown in FIGS. 7 and 8, the groove width of the linear portion 61 is constant, but the groove width of the groove end portion 62 increases toward the side of the coil arrangement hole 80A. The groove end portion 62 includes a pair of side surfaces 621 and 622 that face each other in the X direction that is the groove-width direction of the guide groove 6. The one side surface 621 includes an R-shaped chamfered portion 623 connected to the inner peripheral surface of the coil arrangement hole 80A on the Y1 direction. The other side surface 622 includes an R-shaped chamfered portion 624 connected to the inner peripheral surface of the coil arrangement hole 80A on the X1 direction or the X2 direction.

As shown in FIG. 10, the bottom surface 63 of the guide groove 6 has a shape in which a convex curved surface and a flat surface are smoothly connected to each other, and has no corner. As shown in FIGS. 7 and 10, the bottom surface 63 of the guide groove 6 includes a first region 64 that is an end portion on the coil arrangement hole 80A side, a second region 65 that is an end portion on the substrate holding portion 90 side, and a third region 66 that connects the first region 64 and the second region 65. The first region 64 and the second region 65 are convex curved surfaces. The third region 66 includes a flat surface 67 connected to the second region 65 and a convex curved surface 68 connected to the first region 64. The flat surface 67 is a plane along the XY plane. The convex curved surface 68 is smoothly connected to the flat surface 67. A tangent plane at an end portion of the convex curved surface 68 on the Y1 side is flush with the flat surface 67. The convex curved surface 68 is, as a whole, inclined in a direction toward the Z2 direction as the convex curved surface 68 extends toward the side of the coil arrangement hole 80A (Y2 side), but is not a flat inclined surface but a gentle convex curved surface.

The first region 64 is a convex curved surface that is inclined in a direction toward the Z2 direction as the first region 64 extends toward the side of the coil arrangement hole 80A (Y2 direction). In this embodiment, the first region 64 is an arc surface. The first region 64 may be a curved surface that is not an arc surface. The first region 64 is smoothly connected to an end portion of the third region 66 on the Y2 side. That is, the tangent plane at the end portion of the convex curved surface 68 on the Y2 side is the same plane as the tangent plane at the end portion of the first region 64 on the Y1 side.

The second region 65 is a convex curved surface that is inclined in a direction toward the Z2 direction as the second region 65 extends toward the side of the substrate holding portion 90 (Y1 direction). In this embodiment, the second region 65 is an arc surface. The second region 65 may be a curved surface that is not an arc surface. The second region 65 is smoothly connected to an end portion of the third region 66 on the Y1 side. That is, the flat surface 67 is the same surface as the tangent plane at the end portion of the second region 65 on the Y2 side.

As shown in FIGS. 8 and 10, the first region 64 extends to an end portion of the coil arrangement hole 80A on the Z2 direction. As described above, the portions of the side surfaces 621 and 622 of the guide grooves 6 connected to the inner peripheral surface of the coil arrangement hole 80A have an R-shape. Therefore, when the lead-out wires 84A and 84B are bent to the Z1 direction at the end portion of the winding portion 83 on the Y1 direction and drawn into the guide grooves 6, the lead-out wires 84A and 84B do not come into contact with the corner portion of the coil holder 10.

The second region 65 of the guide groove 6 is connected to the opening portion 60 that opens on the surface of the substrate holding portion 90. As shown in FIG. 10, the tangent plane at the end portion of the second region 65 on the Y1 side is a plane along the XZ plane, and the end portion of the second region 65 on the Y1 side is smoothly connected to the surface of the substrate accommodating concave portion 91. Therefore, when the lead-out wires 84A and 84B are led out from the opening portions 60 and bent to the Z2 direction, the lead-out wires 84A and 84B do not contact the corner portion of the coil holder 10.

### Abutment Portion

When an impact such as a drop is applied to the actuator 1, the movable body 5 may move in the Y direction by a distance larger than the vibration stroke when the movable body 5 is driven by the magnetic drive circuit 8. In this case, an abutment portion provided on the support body 2 collides with the yoke 50 in the Y direction. In the present embodiment, each of the first case 21 and the second case 22 is provided with an abutment portion that collides with the yoke 50 in the Y direction.

The yoke 50 is provided with a yoke side abutment portion that collides with the abutment portion of the support body 2 in the Y direction. As shown in FIG. 2, in the yoke 50, the widths of the first plate portion 51 and the second plate portion 52 in the X direction are larger than those of the first connecting plate portion 53 and the second connecting plate portion 54. The yoke side abutment portion is provided at both end portions in the X direction of the first plate portion 51 and the second plate portion 52.

As shown in FIG. 2, the yoke side abutment portion includes a yoke side first abutment portion 57 provided at an end portion of the yoke 50 on the Y1 direction, and a yoke side second abutment portion 58 provided at an end portion of the yoke 50 on the Y2 direction. The yoke side first abutment portion 57 is provided at four positions, i.e., at both ends in the X direction on the end portion of the first plate portion 51 on the Y1 direction and at both ends in the X direction on the end portion of the second plate portion 52 on the Y1 direction. The positions of the four yoke side first abutment portions 57 in the Y direction coincide with each other. The yoke side second abutment portion 58 is provided at four positions, i.e., at both ends in the X direction on the end portion of the first plate portion 51 on the Y2 direction and at both ends in the X direction on the end portion of the second plate portion 52 on the Y2 direction. The positions of the four yoke side second abutment portions 58 in the Y direction coincide with each other.

As shown in FIG. 2, the second case 22 includes first abutment portions 34 facing in the Y direction the two yoke side first abutment portions 57 provided on the second plate portion 52, and second abutment portions 35 facing in the Y direction the two yoke side second abutment portions 58 provided on the second plate portion 52. As shown in FIG. 2, among the boss portions 31 provided at four corners of the second case 22, two boss portions 31 positioned on the end portion on the Y1 side of the second case 22 each include, on the Y2 side, a side surface that functions as the first abutment portion 34. Further, two boss portions 31 positioned on the end portion on the Y2 side of the second case 22 each include, on the Y1 side, a side surface that functions as the second abutment portion 35.

As described above, structures similar to the first abutment portion 34 and the second abutment portion 35 of the second case 22 are provided inside the first case 21. That is, boss portions (not shown) through which the fixing holes 24 pass are provided at four corners inside the first case 21. Two boss portions (not shown) provided on the end portion on the Y1 side of the first case 21 function as first abutment portions that face, in the Y direction, two yoke side first abutment portions 57 provided on the first plate portion 51. Further, two boss portions (not shown) provided on the end portion on the Y2 side of the first case 21 function as second abutment portions that face, in the Y direction, two yoke side second abutment portions 58 provided on the first plate portion 51.

The position of the first abutment portion provided on the first case 21 coincides with the position of the first abutment portion 34 of the second case 22 in the Y direction. Further, the position of the second abutment portion provided on the first case 21 coincides with the position of the second abutment portion 35 of the second case 22 in the Y direction.

### Collision Avoidance Structure Around First Through Portion

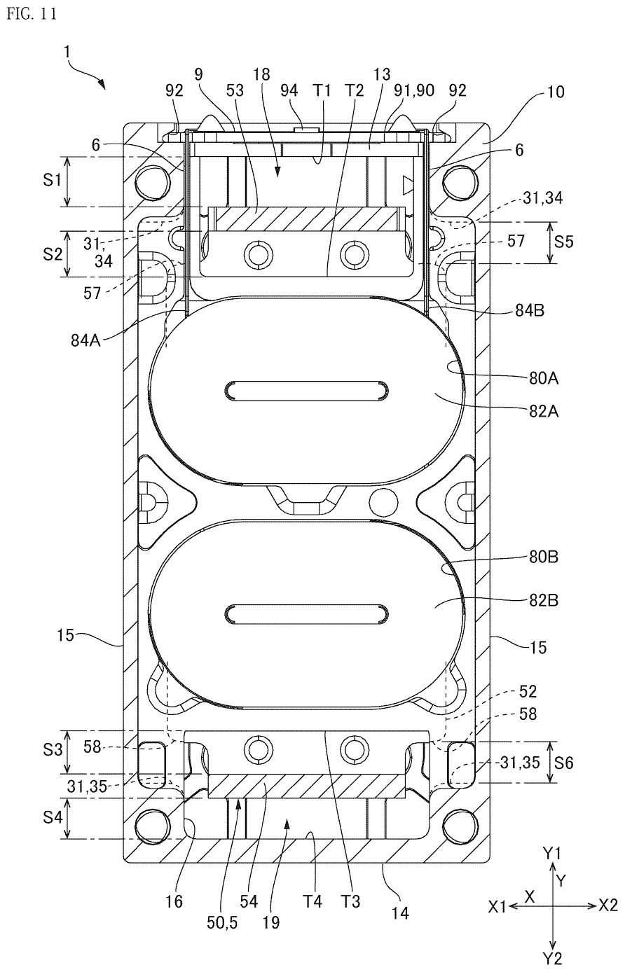

FIG. 11 is a cross-sectional view of the actuator 1 taken along the XY plane, that is, a cross-sectional view of the actuator 1 taken along a D-D position in FIG. 3. When the movable body 5 vibrates in the Y direction, the first connecting plate portion 53 of the yoke 50 moves in the Y direction in the first through portion 18 of the coil holder 10, and the second connecting plate portion 54 moves in the Y direction in the second through portion 19 of the coil holder 10.

As described above, in this embodiment, when the movable body 5 moves in the Y direction by a movement amount larger than a predetermined vibration stroke, the yoke 50 collides with the abutment portion provided on the support body 2. However, when an impact is applied due to a drop or the like, the movable body 5 may be inclined or may move to a position deviated from the abutment portion, and may further move in the Y direction. In such a case, in the actuator 1, the second connecting plate portion 54 collides with the inner surface of the second through portion 19 in the Y direction before the first connecting plate portion 53 collides with the inner surface of the first through portion 18 in the Y direction.

When the first connecting plate portion 53 collides with the inner surface of the first through portion 18 in the Y direction, an impact toward the Y1 direction is applied to the first end plate portion 13 provided with the substrate holding portion 90, or an impact toward the Y2 direction is applied to a portion of the plate portion 12 where the coil 82A is held. As a result, a large tension may be applied to the lead-out wires 84A and 84B extending in the Y direction from the coil 82A to the power supply substrate 9, and the lead-out wires 84A and 84B may be disconnected. Therefore, the actuator 1 is configured to avoid the collision between the first connecting plate portion 53 and the inner surface of the first through portion 18 in the Y direction, and thereby suppressing the disconnection of the lead-out wires 84A and 84B.

As shown in FIG. 11, the inner surface of the first through portion 18 includes a first facing portion T1 that faces the first connecting plate portion 53 from the Y1 side (that is, the side of the power supply substrate 9), and a second facing portion T2 that faces the first connecting plate portion 53 from the Y2 side (that is, the side opposite to the power supply substrate 9). A distance in the Y direction between the first facing portion T1 and the first connecting plate portion 53 is defined as a first distance S1, and a distance in the Y direction between the second facing portion T2 and the first connecting plate portion 53 is defined as a second distance S2.

Similarly, the inner surface of the second through portion 19 includes a third facing portion T3 that faces the second connecting plate portion 54 from the Y1 side (that is, the side of the power supply substrate 9), and a fourth facing portion T4 that faces the second connecting plate portion 54 from the Y2 side (that is, the side opposite to the power supply substrate 9). A distance in the Y direction between the third facing portion T3 and the second connecting plate portion 54 is defined as a third distance S3, and a distance in the Y direction between the fourth facing portion T4 and the second connecting plate portion 54 is defined as a fourth distance S4.

In the coil holder 10, the opening width in the Y direction of the first through portion 18 is different from that of the second through portion 19, and the opening width in the Y direction of the first through portion 18 is larger than that of the second through portion 19. The first connecting plate portion 53 and the second connecting plate portion 54 are arranged such that the first distance S1 is larger than the third distance S3 and the second distance S2 is larger than the fourth distance S4. When S1>S3 and the movable body 5 moves to the Y1 direction, the first connecting plate portion 53 does not collide with the first facing portion T1 before the second connecting plate portion 54 collides with the third facing portion T3. In addition, when S2>S4 and the movable body 5 moves to the Y2 direction, the first connecting plate portion 53 does not collide with the second facing portion T2 before the second connecting plate portion 54 collides with the fourth facing portion T4. Therefore, it is possible to avoid disconnection of the lead-out wires 84A and 84B due to a large tension applied thereto.

In FIG. 11, the positions in the Y direction of the first abutment portion 34 and the second abutment portion 35 provided in the second case 22 are indicated by broken lines. Further, the positions in the Y direction of the yoke side first abutment portion 57 and the yoke side second abutment portion 58 provided on the second plate portion 52 of the yoke 50 are indicated by broken lines. A distance in the Y direction between the first abutment portion 34 and the yoke side first abutment portion 57 is defined as a fifth distance S5, and a distance in the Y direction between the second abutment portion 35 and the yoke side second abutment portion 58 is defined as a sixth distance S6.

Since the positions of the first and second abutment portions of the first case 21 and the positions of the first and second abutment portions of the second case 22 coincide with each other in the Y direction, a distance between the first abutment portion (not shown) of the first case 21 and the yoke side first abutment portion 57 in the Y direction coincide with the fifth distance S5, and a distance between the second abutment portion (not shown) of the first case 21 and the yoke side second abutment portion 58 in the Y direction coincide with the sixth distance S6.

As described above, in this embodiment, when the movable body 5 moves in the Y direction, the abutment portion of the support body 2 and the yoke 50 first collide with each other. Therefore, the fifth distance S5 is shorter than the third distance S3, and the sixth distance S6 is shorter than the fourth distance S4.

### Main Operational Advantages of Present Embodiment

As described above, the actuator 1 of the present embodiment includes the support body 2 and the movable body 5, the connection body 7 that has at least one of elastic property and viscoelastic property, is disposed at a position where the movable body 5 and the support body 2 face each other, and connects the movable body 5 and the support body 2 to each other, and the magnetic drive circuit 8 that comprises the coils 82A and 82B disposed in the coil holder 10 provided on the support body 2 and the magnets 81A and 81B fixed to the yoke 50 provided on the movable body 5 and facing the coil 82A and 82B in the Z direction, and vibrates the movable body 5 with respect to the support body 2 in the Y direction intersecting with the Z direction. The power supply substrate 9 is fixed to an end portion of the coil holder 10 in the Y1 direction. The lead-out wires 84A and 84B led out from the coils 82A and 82B extend to the side of the power supply substrate 9 and are soldered to the power supply substrate 9. The coil holder 10 is provided with the coil arrangement holes 80A and 80B, the first through portion 18 located on the side of the power supply substrate 9 with respect to the coil arrangement holes 80A and 80B, and the second through portion 19 located on the side opposite to the power supply substrate 9 with respect to the coil arrangement holes 80A and 80B. The yoke 50 includes a first plate portion 51 facing the coils 82A and 82B from the Z1 direction, a second plate portion 52 facing the coils 82A and 82B from the Z2 direction, a first connecting plate portion 53 extending in the first through portion 18 in the Z direction and connecting the first plate portion 51 and the second plate portion 52, and a second connecting plate portion 54 extending in the second through portion 19 in the Z direction and connecting the first plate portion 51 and the second plate portion 52. When it is assumed that a distance in the Y direction between the first facing portion T1 of the inner surface of the first through portion 18 that faces the first connecting plate portion 53 from the side of the power supply substrate 9 and the first connecting plate portion 53 is defined as the first distance S1, a distance in the Y direction between the second facing portion T2 of the inner surface of the first through portion 18 that faces the first connecting plate portion 53 from the side opposite to the power supply substrate 9 and the first connecting plate portion 53 is defined as the second distance S2, a distance in the Y direction between the third facing portion T3 of the inner surface of the second through portion 19 that faces the second connecting plate portion 54 from the side of the power supply substrate 9 and the second connecting plate portion 54 is defined as the third distance S3, and a distance in the Y direction between the fourth facing portion T4 of the inner surface of the second through portion 19 that faces the second connecting plate portion 54 from the side opposite to the power supply substrate 9 and the second connecting plate portion 54 is defined as the fourth distance S4, the first distance S1 is larger than the third distance S3 and the second distance S2 is larger than the fourth distance S4.

As described above, in this embodiment, when the movable body 5 largely moves in the Y direction, the second connecting plate portion 54 collides with the inner surface of the second through portion 19 in the Y direction before the first connecting plate portion 53 collides with the inner surface of the first through portion 18 in the Y direction. Therefore, it is possible to prevent the first connecting plate portion 53 from colliding with the inner surface of the first through portion 18 in the Y direction. Accordingly, since it is possible to prevent a large tensile force from being applied to the lead-out wires 84A and 84B extending in the Y direction toward the power supply substrate 9 around the first through portion 18, there is little possibility that the lead-out wires 84A and 84B are disconnected at the time of an impact such as a drop. In addition, it is not necessary to provide slack in the lead-out wires 84A and 84B in order to prevent the lead-out wires 84A and 84B from being disconnected.

In the present embodiment, by setting the dimensions such that S1>S3 and S2>S4, the collision between the movable body 5 and the coil holder 10 can be avoided even when the movable body 5 moves to any of the Y1 direction and the Y2 direction. However, the present embodied may be configured so that only one of the dimensional relationships of S1>S3 and S2>S4 is satisfied. If S1>S3 is satisfied, it is possible to avoid a collision between the first connecting plate portion 53 and the first facing portion T1 when the movable body 5 moves to the Y1 direction. On the other hand, if S2>S4 is satisfied, it is possible to avoid a collision between the first connecting plate portion 53 and the second facing portion T2 when the movable body 5 moves to the Y2 direction.

In this embodiment, the support body 2 includes the first abutment portion 34 facing the yoke 50 from the Y1 direction and the second abutment portion 35 facing the yoke 50 from the Y2 direction. When a distance between the yoke 50 and the first abutment portion 34 in the Y direction is defined as the fifth distance S5 and a distance between the yoke 50 and the second abutment portion 35 in the Y direction is defined as the sixth distance S6, the fifth distance S5 is smaller than the third distance S3 and the sixth distance S6 is smaller than the fourth distance S4. As described above, when the abutment portion that collides with the yoke 50 in the Y direction is additionally provided, the impact can be received by the abutment portion at the time of the impact such as a drop.

In this embodiment, the yoke 50 is provided with the yoke side first abutment portion 57 at both ends in the X direction of the end portion on the Y1 direction, and the yoke side second abutment portion 58 at both ends in the X direction of the end portion on the Y2 direction. The first abutment portion 34 is provided at a position facing each of the yoke side first abutment portions 57 in the Y direction, and the second abutment portion 35 is provided at a position facing each of the yoke side second abutment portions 58 in the Y direction. As described above, when the abutment portion is disposed at both ends in the X direction, there is little possibility that the movable body is inclined at the time of collision with the abutment portion, and thus, there is little possibility that an unexpected portion is broken by collision.

In this embodiment, the yoke side first abutment portion 57 is provided at four positions, i.e., at both ends in the X direction on the end portion of the first plate portion 51 on the Y1 direction and at both ends in the X direction on the end portion of the second plate portion 52 on the Y1 direction, and the yoke side second abutment portion 58 is provided at four positions, i.e., at both ends in the X direction on the end portion of the first plate portion 51 on the Y2 direction and at both ends in the X direction on the end portion of the second plate portion 52 on the Y2 direction. As described above, when the abutment portion is disposed at both ends in the Z direction, there is less possibility that the movable body is inclined at the time of collision with the abutment portion, and thus, there is less possibility that an unexpected portion is broken by collision.

In this embodiment, the support body 2 includes a first case 21 that overlaps the coil holder 10 from the Z1 direction and a second case 22 that overlaps the coil holder 10 from the Z2 direction, and the first abutment portion and the second abutment portion are provided in each of the first case 21 and the second case 22. As described above, by providing the abutment portion on a component different from the coil holder 10, it is possible to reduce impact and tensile force applied to the lead-out wires 84A and 84B disposed on the coil holder 10.

In this embodiment, the coil holder 10 is provided with the pair of guide grooves 6 extending from the coil arrangement hole 80A to the side of the power supply substrate 9 on both sides of the first through portion 18 in the X direction, the coil arrangement holes 80A and 80B arranged in the Y direction are provided between the first through portion 18 and the second through portion 19, the lead-out wire 84A led out from the coil 82A arranged in the coil arrangement hole 80A is arranged in one of the pair of guide grooves 6, and the lead-out wire 84B led out from the coil 82B arranged in the coil arrangement hole 80B is arranged in the other of the pair of guide grooves 6. As described above, by arranging the lead-out wires 84A and 84B in the guide grooves 6, the lead-out wires 84A and 84B are less likely to float from the coil holder 10 and the lead-out wires 84A and 84B are less likely to be disconnected due to collision with other components.

### SUMMARY

At least an embodiment of the present invention can take the following forms.
(1)

An actuator comprising:
a support body and a movable body;
a connection body that has at least one of elastic property and viscoelastic property, is disposed at a position where the movable body and the support body face each other, and connects the movable body and the support body to each other; and
a magnetic drive circuit that comprises a coil disposed in a coil holder provided on the support body and a magnet fixed to a yoke provided on the movable body and facing the coil in a first direction, and vibrates the movable body with respect to the support body in a second direction intersecting the first direction, wherein
a power supply substrate is fixed to an end portion of the coil holder on one side in the second direction, and a lead-out wire led out from the coil extends toward a side of the power supply substrate and is soldered to the power supply substrate,
the coil holder is provided with a coil arrangement hole in which the coil is arranged, a first through portion located on a side of the power supply substrate with respect to the coil arrangement hole, and a second through portion located on a side opposite to the power supply substrate with respect to the coil arrangement hole, and
the yoke comprises a first plate portion facing the coil from one side in the first direction, a second plate portion facing the coil from an other side in the first direction, a first connecting plate portion extending in the first through portion in the first direction and connecting the first plate portion and the second plate portion, and a second connecting plate portion extending in the second through portion in the first direction and connecting the first plate portion and the second plate portion, and
when it is assumed that
   a distance in the second direction between a first facing portion of an inner surface of the first through portion that faces the first connecting plate portion from a side of the power supply substrate and the first connecting plate portion is defined as a first distance,
   a distance in the second direction between a second facing portion of an inner surface of the first through portion that faces the first connecting plate portion from a side opposite to the power supply substrate and the first connecting plate portion is defined as a second distance,
   a distance in the second direction between a third facing portion of an inner surface of the second through portion that faces the second connecting plate portion from a side of the power supply substrate and the second connecting plate portion is defined as a third distance, and
   a distance in the second direction between a fourth facing portion of an inner surface of the second through portion that faces the second connecting plate portion from a side opposite to the power supply substrate and the second connecting plate portion is defined as a fourth distance,
the first distance is larger than the third distance.
(2)

The actuator according to claim 1, wherein the second distance is larger than the fourth distance.
(3)

An actuator comprising:
a support body and a movable body;
a connection body that has at least one of elastic property and viscoelastic property, is disposed at a position where the movable body and the support body face each other, and connects the movable body and the support body to each other; and
a magnetic drive circuit that comprises a coil disposed in a coil holder provided on the support body and a magnet fixed to a yoke provided on the movable body and facing the coil in a first direction, and vibrates the movable body with respect to the support body in a second direction intersecting the first direction, wherein
a power supply substrate is fixed to an end portion of the coil holder on one side in the second direction, and a lead-out wire led out from the coil extends toward a side of the power supply substrate and is soldered to the power supply substrate,
the coil holder is provided with a coil arrangement hole in which the coil is arranged, a first through portion located on a side of the power supply substrate with respect to the coil arrangement hole, and a second through portion located on a side opposite to the power supply substrate with respect to the coil arrangement hole, and
the yoke comprises a first plate portion facing the coil from one side in the first direction, a second plate portion facing the coil from an other side in the first direction, a first connecting plate portion extending in the first through portion in the first direction and connecting the first plate portion and the second plate portion, and a second connecting plate portion extending in the second through portion in the first direction and connecting the first plate portion and the second plate portion, and
when it is assumed that
   a distance in the second direction between a first facing portion of an inner surface of the first through portion that faces the first connecting plate portion from a side of the power supply substrate and the first connecting plate portion is defined as a first distance,
   a distance in the second direction between a second facing portion of an inner surface of the first through portion that faces the first connecting plate portion from a side opposite to the power supply substrate and the first connecting plate portion is defined as a second distance,
   a distance in the second direction between a third facing portion of an inner surface of the second through portion that faces the second connecting plate portion from a side of the power supply substrate and the second connecting plate portion is defined as a third distance, and
   a distance in the second direction between a fourth facing portion of an inner surface of the second through portion that faces the second connecting plate portion from a side opposite to the power supply substrate and the second connecting plate portion is defined as a fourth distance,
the second distance is larger than the fourth distance.
(4)

The actuator according to any one of (1) to (3) described above, wherein the support body comprises:
a first abutment portion facing the yoke from one side in the second direction; and
a second abutment portion facing the yoke from an other side in the second direction, and
when it is assumed that
   a distance between the yoke and the first abutment portion in the second direction is defined as a fifth distance, and
   a distance between the yoke and the second abutment portion in the second direction is defined as a sixth distance,
the fifth distance is smaller than the third distance, and
the sixth distance is smaller than the fourth distance.
(5)

The actuator according to (4) described above, wherein
when a direction crossing the first direction and crossing the second direction is defined as a third direction,
the yoke is provided with a first yoke side abutment portion at both ends in the third direction of an end portion on one side in the second direction, and a second yoke side abutment portion at both ends in the third direction of an end portion on an other side in the second direction,
the first abutment portion is provided at a position facing each of the first yoke side abutment portions in the second direction, and
the second abutment portion is provided at a position facing each of the second yoke side abutment portions in the second direction.
(6)

The actuator according to (5) described above, wherein
the first yoke side abutment portion is provided at each of four positions including both ends in the third direction of an end portion of the first plate portion on one side in the second direction, and both ends in the third direction of an end portion of the second plate portion on one side in the second direction, and
the second yoke side abutment portion is provided at each of four positions including both ends in the third direction of an end portion of the first plate portion on an other side in the second direction, and both ends in the third direction of an end portion of the second plate portion on an other side in the second direction.
(7)

The actuator according to (4) described above, wherein
the support body includes a first case that overlaps the coil holder from one side in the first direction and a second case that overlaps the coil holder from an other side in the first direction, and
the first abutment portion and the second abutment portion are provided on each of the first case and the second case.
(8)

The actuator according to any one of (1) to (3) described above, wherein
when a direction crossing the first direction and crossing the second direction is defined as a third direction,
the coil holder is provided with a pair of guide grooves extending from the coil arrangement hole to a side of the power supply substrate on both sides in the third direction of the first through portion, and
a first coil arrangement hole and a second coil arrangement hole arranged in the second direction are provided as the coil arrangement holes between the first through portion and the second through portion,
the lead-out wire led out from the coil arranged in the first coil arrangement hole is arranged in one of the pair of guide grooves, and
the lead-out wire led out from the coil arranged in the second coil arrangement hole is arranged in an other of the pair of guide grooves.

What is claimed is:

1. An actuator comprising:
a support body and a movable body;
a connection body that has at least one of elastic property and viscoelastic property, is disposed at a position where the movable body and the support body face each other, and connects the movable body and the support body to each other; and
a magnetic drive circuit that comprises a coil disposed in a coil holder provided on the support body and a magnet fixed to a yoke provided on the movable body and facing the coil in a first direction, and vibrates the movable body with respect to the support body in a second direction intersecting the first direction, wherein
a power supply substrate is fixed to an end portion of the coil holder on one side in the second direction, and a lead-out wire led out from the coil extends toward a side of the power supply substrate and is soldered to the power supply substrate,
the coil holder is provided with a coil arrangement hole in which the coil is arranged, a first through portion located on a side of the power supply substrate with respect to the coil arrangement hole, and a second through portion located on a side opposite to the power supply substrate with respect to the coil arrangement hole, and
the yoke comprises a first plate portion facing the coil from one side in the first direction, a second plate portion facing the coil from an other side in the first direction, a first connecting plate portion extending in the first through portion in the first direction and connecting the first plate portion and the second plate portion, and a second connecting plate portion extending in the second through portion in the first direction and connecting the first plate portion and the second plate portion, and
when it is assumed that
a distance in the second direction between a first facing portion of an inner surface of the first through portion that faces the first connecting plate portion from a side of the power supply substrate and the first connecting plate portion is defined as a first distance,
a distance in the second direction between a second facing portion of an inner surface of the first through portion that faces the first connecting plate portion from a side opposite to the power supply substrate and the first connecting plate portion is defined as a second distance,
a distance in the second direction between a third facing portion of an inner surface of the second through portion that faces the second connecting plate portion from a side of the power supply substrate and the second connecting plate portion is defined as a third distance, and
a distance in the second direction between a fourth facing portion of an inner surface of the second through portion that faces the second connecting plate portion from a side opposite to the power supply substrate and the second connecting plate portion is defined as a fourth distance,
the first distance is larger than the third distance.

2. The actuator according to claim 1, wherein the second distance is larger than the fourth distance.

3. An actuator comprising:
a support body and a movable body;
a connection body that has at least one of elastic property and viscoelastic property, is disposed at a position where the movable body and the support body face each other, and connects the movable body and the support body to each other; and
a magnetic drive circuit that comprises a coil disposed in a coil holder provided on the support body and a magnet fixed to a yoke provided on the movable body and facing the coil in a first direction, and vibrates the movable body with respect to the support body in a second direction intersecting the first direction, wherein
a power supply substrate is fixed to an end portion of the coil holder on one side in the second direction, and a lead-out wire led out from the coil extends toward a side of the power supply substrate and is soldered to the power supply substrate,
the coil holder is provided with a coil arrangement hole in which the coil is arranged, a first through portion located on a side of the power supply substrate with respect to the coil arrangement hole, and a second through portion located on a side opposite to the power supply substrate with respect to the coil arrangement hole, and
the yoke comprises a first plate portion facing the coil from one side in the first direction, a second plate portion facing the coil from an other side in the first direction, a first connecting plate portion extending in the first through portion in the first direction and connecting the first plate portion and the second plate portion, and a second connecting plate portion extending in the second through portion in the first direction and connecting the first plate portion and the second plate portion, and
when it is assumed that
a distance in the second direction between a first facing portion of an inner surface of the first through portion that faces the first connecting plate portion from a side of the power supply substrate and the first connecting plate portion is defined as a first distance,
a distance in the second direction between a second facing portion of an inner surface of the first through portion that faces the first connecting plate portion from a side opposite to the power supply substrate and the first connecting plate portion is defined as a second distance,
a distance in the second direction between a third facing portion of an inner surface of the second through portion that faces the second connecting plate portion from a side of the power supply substrate and the second connecting plate portion is defined as a third distance, and
a distance in the second direction between a fourth facing portion of an inner surface of the second through portion that faces the second connecting plate portion from a side opposite to the power supply substrate and the second connecting plate portion is defined as a fourth distance,
the second distance is larger than the fourth distance.

4. The actuator according to claim 1, wherein the support body comprises:
a first abutment portion facing the yoke from one side in the second direction; and
a second abutment portion facing the yoke from an other side in the second direction, and
when it is assumed that
a distance between the yoke and the first abutment portion in the second direction is defined as a fifth distance, and
a distance between the yoke and the second abutment portion in the second direction is defined as a sixth distance,
the fifth distance is smaller than the third distance, and
the sixth distance is smaller than the fourth distance.

5. The actuator according to claim 4, wherein
when a direction crossing the first direction and crossing the second direction is defined as a third direction,
the yoke is provided with a first yoke side abutment portion at both ends in the third direction of an end portion on one side in the second direction, and a second yoke side abutment portion at both ends in the third direction of an end portion on an other side in the second direction,
the first abutment portion is provided at a position facing each of the first yoke side abutment portions in the second direction, and
the second abutment portion is provided at a position facing each of the second yoke side abutment portions in the second direction.

6. The actuator according to claim 5, wherein
the first yoke side abutment portion is provided at each of four positions including both ends in the third direction of an end portion of the first plate portion on one side in the second direction, and both ends in the third direction of an end portion of the second plate portion on one side in the second direction, and
the second yoke side abutment portion is provided at each of four positions including both ends in the third direction of an end portion of the first plate portion on an other side in the second direction, and both ends in the third direction of an end portion of the second plate portion on an other side in the second direction.

7. The actuator according to claim 4, wherein
the support body includes a first case that overlaps the coil holder from one side in the first direction and a second case that overlaps the coil holder from an other side in the first direction, and
the first abutment portion and the second abutment portion are provided on each of the first case and the second case.

8. The actuator according to claim 1, wherein
when a direction crossing the first direction and crossing the second direction is defined as a third direction,
the coil holder is provided with a pair of guide grooves extending from the coil arrangement hole to a side of the power supply substrate on both sides in the third direction of the first through portion, and
a first coil arrangement hole and a second coil arrangement hole arranged in the second direction are provided as the coil arrangement holes between the first through portion and the second through portion,
the lead-out wire led out from the coil arranged in the first coil arrangement hole is arranged in one of the pair of guide grooves, and
the lead-out wire led out from the coil arranged in the second coil arrangement hole is arranged in an other of the pair of guide grooves.

9. The actuator according to claim 2, wherein
when a direction crossing the first direction and crossing the second direction is defined as a third direction,
the coil holder is provided with a pair of guide grooves extending from the coil arrangement hole to a side of the power supply substrate on both sides in the third direction of the first through portion, and
a first coil arrangement hole and a second coil arrangement hole arranged in the second direction are provided as the coil arrangement holes between the first through portion and the second through portion,
the lead-out wire led out from the coil arranged in the first coil arrangement hole is arranged in one of the pair of guide grooves, and
the lead-out wire led out from the coil arranged in the second coil arrangement hole is arranged in an other of the pair of guide grooves.

10. The actuator according to claim 3, wherein
when a direction crossing the first direction and crossing the second direction is defined as a third direction,
the coil holder is provided with a pair of guide grooves extending from the coil arrangement hole to a side of the power supply substrate on both sides in the third direction of the first through portion, and
a first coil arrangement hole and a second coil arrangement hole arranged in the second direction are provided as the coil arrangement holes between the first through portion and the second through portion,
the lead-out wire led out from the coil arranged in the first coil arrangement hole is arranged in one of the pair of guide grooves, and
the lead-out wire led out from the coil arranged in the second coil arrangement hole is arranged in an other of the pair of guide grooves.

11. The actuator according to claim 2, wherein the support body comprises:
a first abutment portion facing the yoke from one side in the second direction; and
a second abutment portion facing the yoke from an other side in the second direction, and
when it is assumed that
a distance between the yoke and the first abutment portion in the second direction is defined as a fifth distance, and
a distance between the yoke and the second abutment portion in the second direction is defined as a sixth distance,
the fifth distance is smaller than the third distance, and
the sixth distance is smaller than the fourth distance.

12. The actuator according to claim 3, wherein the support body comprises:
a first abutment portion facing the yoke from one side in the second direction; and
a second abutment portion facing the yoke from an other side in the second direction, and
when it is assumed that
a distance between the yoke and the first abutment portion in the second direction is defined as a fifth distance, and
a distance between the yoke and the second abutment portion in the second direction is defined as a sixth distance,
the fifth distance is smaller than the third distance, and
the sixth distance is smaller than the fourth distance.
